(19) United States
(12) Patent Application Publication
(10) Pub. No.: US 2006/0102785 A1
(43) Pub. Date: May 18, 2006

(54) Airplane seating arrangement

(76) Inventor: Thomas John Butt, Phoenix, AZ (US)

Correspondence Address: ETHERTON LAW GROUP, LLC, 5555 E. VAN BUREN STREET, SUITE 100, PHOENIX, AZ, 85008, US

(21) Appl. No.: 10/965,949

(22) Filed: Oct. 14, 2004

(51) Int. Cl. B64D 11/06

(52) U.S. Cl. 244/118.6

(57) ABSTRACT

A method for increasing airline revenue with an improved passenger seating arrangement for passenger jets. A sufficient number of aisles are used such that the number of contiguous seats in each row does not exceed two. The seats and aisles can be arranged in multiple configurations. In the preferred embodiment there is only one class of seating and the ticket prices for a given origin-destination flight are increased over what is charged for a seat on an airplane having conventional seating arrangement for the same origin-destination flight. In the preferred embodiment, each row of a narrow-body jet has five seats and two aisles.

### FIELD OF INVENTION

This invention relates generally to an improved method for accommodating passenger loads in aircraft and more specifically to a seating arrangement for passenger jets which increases passenger comfort and airline revenue.

### BACKGROUND

Commercial airlines and airplane manufacturers seek to arrange passenger seats in ways that maximize the revenue-earning potential of airplanes while minimizing operating costs per passenger seat. For existing airplane models, seats are arranged with the objective of maximizing passenger comfort without reducing the number of seats, or of maximizing the number of seats at a given level of passenger comfort. Conventional design of new airplane seating arrangements seeks to minimize the dimensions of the airplane (and the resulting weight and aerodynamic drag) to accommodate a given number of seats at a given comfort level.

With respect to the arrangement of seats in each row, it is a fundamental principle that maximum comfort is achieved with wider seats and increased distance (pitch) from the seat in front of it. Further, overall passenger comfort is maximized by minimizing the number of seats between any passenger and the nearest aisle. Among practical configurations, those in which no passenger is more than one seat away from the nearest aisle are considered ideal.

For existing planes having eight-abreast configurations with two aisles, these rules have resulted in the use of a 2+4+2 rows (where “+” represents the position of an aisle and numerals are used to indicate the number of seats). The seating arrangements disclosed in U.S. Pat. No. 5,611,503 issued Mar. 18, 1997 to Brauer; U.S. Pat. No. 4,066,227, issued Jan. 3, 1978, to Buchsel; U.S. Pat. No. 4,881,702, issued Nov. 21, 1989, to Slettebak; U.S. Pat. No. 4,936,620, issued Jun. 26, 1990, to Francois et al.; U.S. Pat. No. 5,178,345, issued Jan. 12, 1993, issued to Peltola et al., and U.S. Pat. No. 5,180,120, issued Jan. 19, 1993, to Simpson, et al., observe these principles.

However, none of these seating arrangements take into account the reality of today's airline market: narrow-body jets are used for a large amount of airline traffic. Comfort is a critical factor, as evidenced by customer's willingness to pay more to upgrade to first class when available in order to get more comfort. However, comfort is an even greater challenge with the narrow-body planes in which the cabin is even less wide than in the wide-body jets.

Passengers take into a number of factors when choosing which flight to take, including destination, number of stops along the way, ticket price, and seat comfort, which is determined primarily by seat class (economy, business or first). Assuming a given destination and a non-stop flight, the remaining factors determining a ticket purchase are the cost and the seat comfort. Given the simplified gross revenue calculation that:
revenue=price×seats filled,
it can be seen that increasing the price per seat or the number of seats filled will increase revenue. Of course, in reality, the revenue calculation takes into account other factors such as different prices for different seats depending on the class of seating or when the ticket is purchased so a closer approximation to actual revenue is:
revenue=Σ(price of a ticket)×(seats filled at that ticket price).
Regardless of which formula is used, maximizing revenue depends on the number of passengers per trip, or “load factor.”

Increasing the load factor increases revenue, but until now this has been accomplished by reducing the ticket price or increasing the number of seats available, which in turn reduces comfort. Alternatively, the revenue can be increased by increasing the price of the tickets, assuming the price increase is not enough to deter passengers from buying tickets. It is a difficult balance to maintain a higher load factor, more comfort, and an acceptable ticket price.

Therefore, it is an object of this invention to provide a seating arrangement that increases passenger comfort that customers seek. This, in turn, will not only maximize the load factor but will also allow an increase in ticket price without deterring passengers, thereby increasing revenue.

### SUMMARY OF THE INVENTION

The present invention is a method for increasing airline revenue with an improved passenger seating arrangement for passenger jets. A sufficient number of aisles are used such that the number of contiguous seats in each row does not exceed two. The seats and aisles can be arranged in multiple configurations. In the preferred embodiment there is only one class of seating and the ticket prices for a given origin-destination flight are increased over what is charged for a seat on an airplane having conventional seating arrangement for the same origin-destination flight. In the preferred embodiment, each row of a narrow-body jet has five seats and two aisles.

### BRIEF DESCRIPTION OF THE DRAWINGS

FIG. 1 is a top view schematic of the prior art, showing a six-abreast seating arrangement in the cabin of an Airbus® 321.

FIG. 2 is a top view schematic of the present invention, showing a five-abreast seating arrangement of cabin of an Airbus® 321.

FIG. 3 illustrates the possible five-abreast configurations of the present invention in which:
(a) shows the 1+2+2 seating arrangement
(b) shows the 2+1+2 seating arrangement
(c) shows the 2+2+1 seating arrangement.

FIG. 4 is a top view schematic of the prior art, showing eight-abreast seating arrangement of cabin of an Airbus® 300.

FIG. 5 is a top view schematic of the present invention, showing a seven-abreast seating arrangement of cabin of an Airbus® 300.

FIG. 6 illustrates the possible seven-abreast configurations of the present invention in which:
(a) shows the 1+2+2+2 seating arrangement
(b) shows the 2+1+2+2 seating arrangement
(c) shows the 2+2+1+2 seating arrangement
(d) shows the 2+2+2+1 seating arrangement.

FIG. 7 illustrates the possible eight-abreast seating arrangement of the present invention with three aisles and the 2+2+2+2 configuration.

FIG. 8 illustrates the possible six-abreast seating arrangement of the present invention with three aisles and the 2+2+2 configuration.

### DETAILED DESCRIPTION OF THE INVENTION

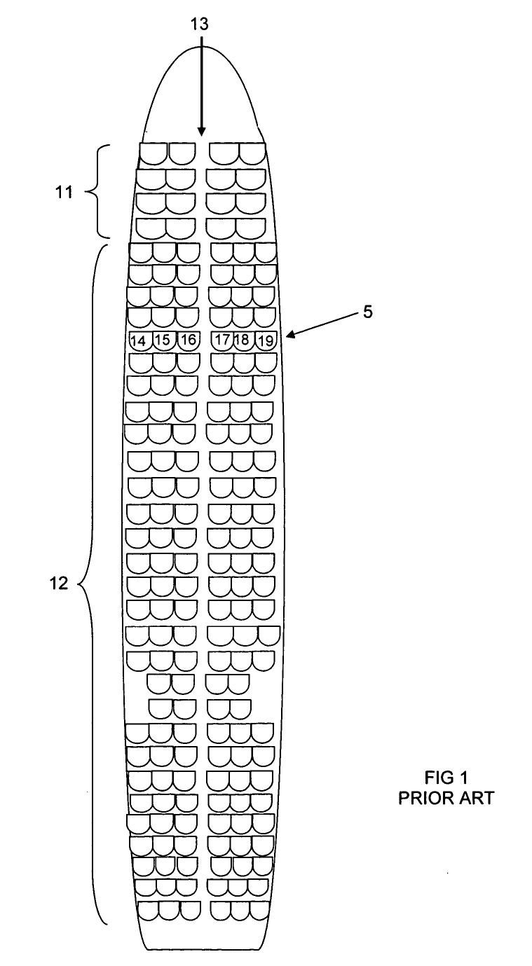

FIG. 1 shows the conventional seating arrangement for the Airbus® 321, a narrow-body jet. Narrow-body jets have a maximum cabin width of about thirteen feet and include other narrow-body jets such as the Airbus® 319 and 320 and Boeing® 737 and 757. The passenger rows are divided between a first class 11 which has four seats per row, and an economy class 12 which has six seats per row. Because of the narrow cabin width, there is enough space for only one aisle 13 in a six-abreast configuration. The fifth row 5 in the economy class is an exemplary row having six seats 14, 15, 16, 17, 18, 19. Missing seats are to accommodate exit doors.

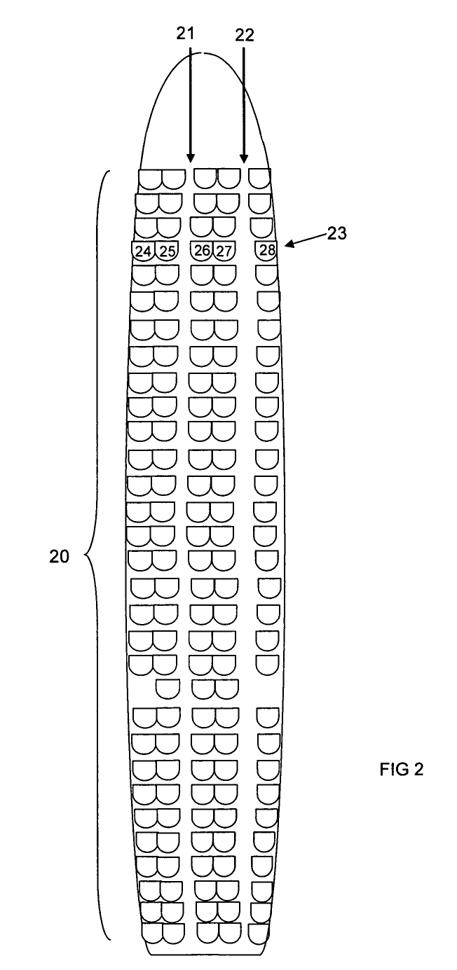

FIG. 2 shows the seating arrangement for the Airbus® 321 employing the present invention. In the preferred embodiment there is only one class 20 of seats and all passenger rows have five seats. The fourth row 23 is an exemplary row having five seats 24, 25, 26, 27, 28. The elimination of one seat per row allows for two aisles 21 and 22. The seats in each passenger row in the airplane are thus configured five-abreast in a 1+2+2, 2+1+2, or 2+2+1 layout, where the “+” indicates and aisle and the numerals indicate the number of seats. See FIG. 3 which illustrates the possible five-abreast seating arrangement with two aisles wherein:
(a) shows the 1+2+2 configuration;
(b) shows the 2+1+2 configuration;
(c) shows the 2+2+1 configuration.

The five-abreast configuration reduces the number of economy seats compared to the two-class, six-abreast seating arrangements. Therefore, to obtain the same potential revenue for a given plane on a given origin-destination flight, first class eating may be removed and the number of economy seats may be increased. For example, an Airbus® 321 typically holds 185 passengers in 33 rows in six-abreast seating. The first four rows hold 16 first class seats and the remaining 29 rows hold 169 economy class seats. Five-abreast seating can generate 163 seats in the same 33 rows by substituting economy class seating for the first class seating and slightly increasing the pitch between all rows, thereby providing more comfort to the passengers. With the increased comfort, passengers will be clamoring for the five-abreast seats and will be willing to pay a premium over the price of a seat on a six-abreast plane. In the revenue calculation, this increased ticket price will offset the decreased number of seats in a five-abreast configuration. As a result, the revenue for a five-abreast seating arrangement is greater than the revenue for a six-abreast seating arrangement.

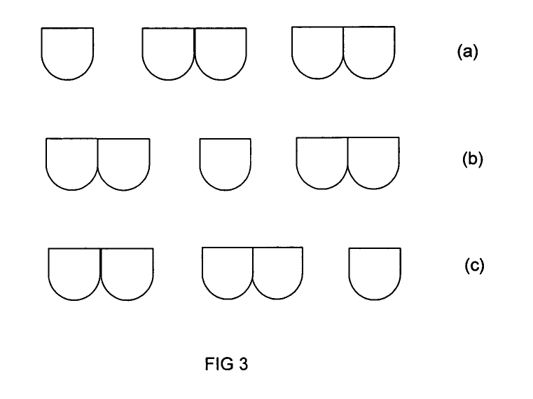

Similarly, the present invention can be used in wide-body jets. Wide-body jets have a maximum cabin width of over about thirteen feet and include jets such as the Airbus® 300, 310, 330, 340 and 380 and Boeing® 747, 767, 777, and 7E7. The wide-body jets typically have only two aisles in any class and seven to nine seats per row in economy class. FIG. 4 is a top view schematic of the prior art, showing an eight-abreast seating arrangement of cabin of an Airbus® 300 with two aisles 41 and 42.

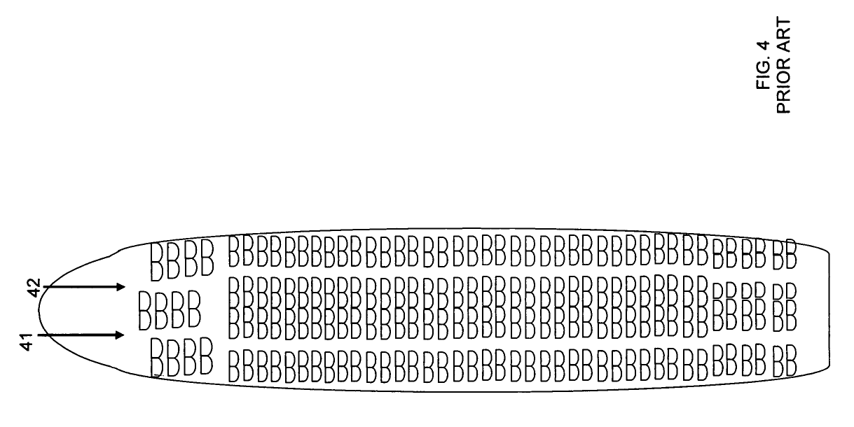

FIG. 5 is a top view schematic of the present invention, showing a seven-abreast seating arrangement of cabin of an Airbus® 300. The fourth row 54 is an exemplary row having seven seats. The elimination of one seat per row allows for three aisles 51, 52, and 53. The seats in each passenger row in the airplane are thus configured seven-abreast in a 2+2+2+1 layout. See FIG. 6 which illustrates the possible seven-abreast seating arrangement with three aisles wherein:
(a) shows the 1+2+2+2 configuration;
(b) shows the 2+1+2+2 configuration;
(c) shows the 2+2+1+2 configuration;
(d) shows the 2+2+2+1 configuration.

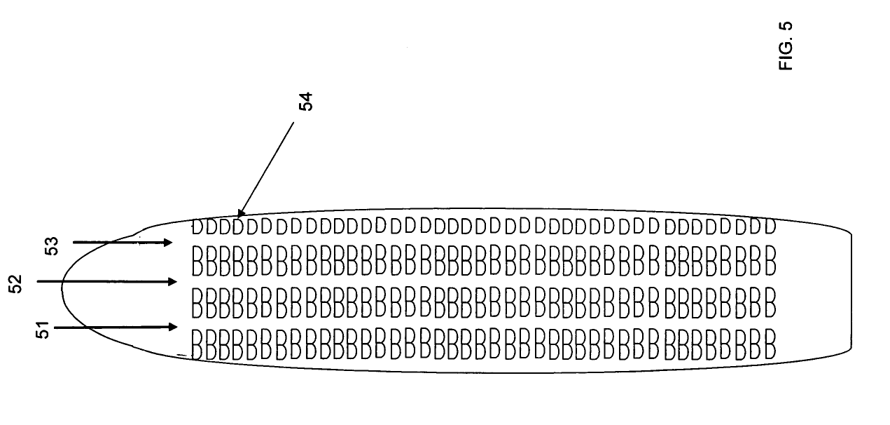

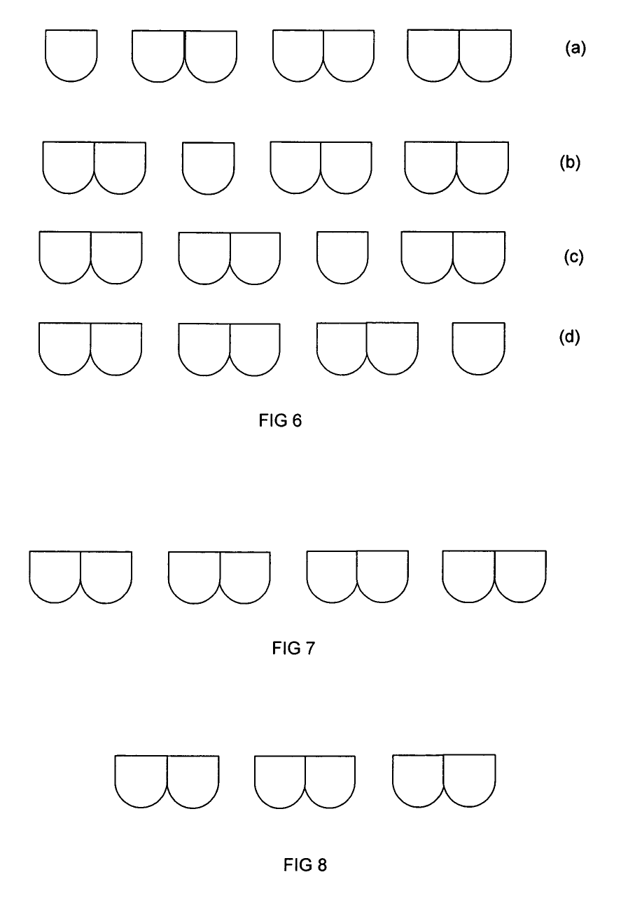

FIG. 7 illustrates the possible eight-abreast seating arrangement with three aisles and the 2+2+2+2 configuration. FIG. 8 illustrates the possible six-abreast seating arrangement of the present invention with three aisles and the 2+2+2 configuration. In sum, the present invention can be used in any size plane with any number of aisles, so long as the maximum number of contiguous seats is two per row.

The configuration with the higher number of aisles reduces the number of economy seats compared to the conventional seating arrangements. Therefore, to obtain the same potential revenue for a given plane on a given origin-destination flight, first class eating may be removed and the number of economy seats may be increased.

Ticket purchasers can be categorized into four price categories. The lowest of the four is the budget traveler, usually the young or poor who travels infrequently and who looks for the most inexpensive ticket regardless of comfort or inconvenience. Next is the traveler who also looks for the cheapest ticket but who will pay a little extra to fly direct to the destination, without intervening stops. The third type is where most business travelers fit: they want a comfortable seat at a low price, but will pay a premium to get a direct flight or a more comfortable seat. The last category is the premium traveler. This traveler will pay more to fly in first class comfort and will pay a premium for a non-stop flight. These travelers will always avoid budget carriers and, if faced with only the economy seats at the time they make reservations, will upgrade for a significant premium on the day of the flight if a first class seat becomes available.

For a given origin-destination flight, revenue is maximized when the plane is filled with all passengers paying the highest price the market will support. There is a strategy of determining how high to set the price of ticket such that the revenue is maximized: too high a price and fewer passengers will buy tickets thus reducing revenue. Too low a price and, while more seats may be filled, the revenue may still be lower than what's possible.

The result of using the present seating arrangement is that the first class flyers retain nearly first class seat comfort, but the significant percentage of customers willing to pay that small premium over the discount fare fill up the now more-comfortable economy seats, leaving only the those consumers truly concerned about the cheapest price regardless of comfort for the discount airlines. The increased load factor will make up for any revenue that is lost due to the reduced number of seats. This increased load factor at a decent price will maximize the revenue per flight.

The benefit of this invention, then, is an increased load factor as more passengers choose to fly in the fewer, but more comfortable seats. By applying this model to highly-traveled routes, the combination of the proper number of rows and an appropriate ticket price will result in increased revenue per available mile (RASM) over existing seat configurations.

The limit on two contiguous seats allows the carrier to provide many more comfortable seats than conventional six-abreast seating model. Since the seats are more comfortable, the business and premium travelers will be willing to pay more to fly in the five-abreast planes. This means that the more comfortable planes will fill up with passengers paying higher prices. The budget travelers will continue to fly the cheapest seats.

The useful result is that the revenue from the passengers buying tickets for the seats in the first plane limiting to two the number of contiguous seats is greater than the revenue from the passengers buying tickets for seats in a second plane without the limit. This means that the RASM for the first plane is greater than the RASM for the second plane. Being able to increase revenue is a substantial step to making airlines profitable. This specific, substantial, and credible utility is what drives airlines to be profitable.

While there has been illustrated and described what is at present considered to be a preferred embodiment of the present invention, it will be understood by those skilled in the art that various changes and modifications may be made, and equivalents may be substituted for elements thereof without departing from the true scope of the invention. Therefore, it is intended that this invention not be limited to the particular embodiment disclosed as the best mode contemplated for carrying out the invention, but that the invention will include all embodiments falling within the scope of the appended claims.

1. An airplane having multiple rows of passenger seats comprising:
a) at least five seats per row;
b) a sufficient number of aisles such that the number of contiguous seats in each row does not exceed two wherein
c) the airplane is a narrow-body aircraft.

2. A narrow-body airplane having multiple rows of passenger seats in which each row has five seats and two aisles.

3. The narrow-body airplane of claim 2 in which the airplane has an interior width of no more than about thirteen feet.

4. The narrow-body airplane of claim 2 in which each row is arranged in a 2+2+1 configuration.

5. The airplane of claim 2 in which each row is arranged in a 2+1+2 configuration.

6. The airplane of claim 2 in which each row is arranged in a 1+2+2 configuration.

7. An airplane having multiple rows of passenger seats in which each row has more than five seats and more than two aisles.

8. The airplane of claim 7 wherein:
a) the airplane has six seats per row; and
b) the six seats are arranged with three aisles; and
c) each row is arranged in a 2+2+2 configuration.

9. The airplane of claim 7 wherein:
a) the airplane has seven seats per row; and
b) the seven seats are arranged with three aisles; and
c) each row is arranged in a 1+2+2+2 configuration.

10. The airplane of claim 7 wherein:
a) the airplane has seven seats per row; and
b) the seven seats are arranged with three aisles; and
c) each row is arranged in a 2+1+2+2 configuration.

11. The airplane of claim 7 wherein:
a) the airplane has seven seats per row; and
b) the seven seats are arranged with three aisles; and
c) each row is arranged in a 2+2+2+1 configuration.

12. The airplane of claim 7 wherein:
a) the airplane has eight seats per row; and
b) the eight seats are arranged with three aisles; and
c) each row is arranged in a 2+2+2+2 configuration.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. An airplane having multiple rows of passenger seats comprising:
a) at least two aisles;
b) at least five seats per row wherein there are no more than two contiguous seats per row; wherein
d) the airplane has an interior width of no more than 13 feet.

25. The airplane of claim 24 wherein the airplane has an interior width of no more than twelve feet.

26. The airplane of claim 24 wherein the airplane has an interior width of no more than eleven feet, seven inches.
